(19) United States
(12) Patent Application Publication
(10) Pub. No.: US 2026/0017139 A1
(43) Pub. Date: Jan. 15, 2026

(54) OPERATION AND MAINTENANCE PLATFORM, FAULT TROUBLESHOOTING METHOD, AND RELATED DEVICE

(71) Applicant: Beijing Volcano Engine Technology Co., Ltd., Beijing (CN)

(72) Inventors: Chunpeng DU, Beijing (CN); Chuanbao SUN, Beijing (CN); Wendong FANG, Beijing (CN)

(21) Appl. No.: 19/071,359

(22) Filed: Mar. 5, 2025

(30) Foreign Application Priority Data
Jul. 9, 2024 (CN) 202410917155.5

(51) Int. Cl. G06F 11/07

(52) U.S. Cl. CPC G06F 11/0793; G06F 11/0769

(57) ABSTRACT

The present disclosure provides an operation and maintenance platform and a fault troubleshooting method. The operation and maintenance platform includes: a debugging interface, a proxy module, and multiple fault troubleshooting engines. The debugging interface is configured to receive operation and maintenance information and return a fault troubleshooting report. The proxy module is configured to determine a backend cloud environment based on environment information in the operation and maintenance information and submit the operation and maintenance information to a fault troubleshooting engine corresponding to the backend cloud environment. The fault troubleshooting engine is configured to determine a fault troubleshooting link graph based on the information on the problem description, perform fault troubleshooting on the maintenance object based on the fault troubleshooting link graph and an identity of the maintenance object, determine a root cause of a fault corresponding to the problem description, and generate the fault troubleshooting report.

### CROSS-REFERENCE TO RELATED APPLICATION(S)

This application claims priority to Chinese Application No. 202410917155.5 filed in Jul. 9, 2024, the disclosure of which is incorporated herein by reference in its entirety.

### FIELD

The present disclosure relates to a field of computer technologies, and in particular, to an operation and maintenance platform, a fault troubleshooting method, and a related device.

### BACKGROUND

With the continuous development of Internet technologies across the world, various Internet service platforms, including recommendation platforms, usually have multiple deployment environments across the world. At present, the operation and maintenance of the service platforms are still mostly manually performed by management personnel. In this manner, when there are more deployment environments for a service platform or the service platform provides more services, the maintenance costs, especially the labor costs, of the service platform will accordingly keep increasing.

### SUMMARY

In view of this, embodiments of the present disclosure provide an operation and maintenance platform, a fault troubleshooting method, and a related device.

The operation and maintenance platform according to the embodiments of the present disclosure may include: a debugging interface, a proxy module, and multiple fault troubleshooting engines, wherein each of the multiple fault troubleshooting engines corresponds to one backend cloud environment.

The debugging interface is configured to receive operation and maintenance information for a specific maintenance object submitted by a service management platform, and return a fault troubleshooting report generated by the fault troubleshooting engine to the service management platform, and wherein the operation and maintenance information includes: an identity of the maintenance object, information on problem description, and environment information.

The proxy module is configured to receive the operation and maintenance information, determine a backend cloud environment corresponding to the maintenance object based on the environment information in the operation and maintenance information, submit the operation and maintenance information to a fault troubleshooting engine corresponding to the backend cloud environment, and return the fault troubleshooting report generated by the fault troubleshooting engine to the debugging interface.

The fault troubleshooting engine is configured to determine a fault troubleshooting link graph corresponding to the information on the problem description in the operation and maintenance information based on the information on the problem description, perform fault troubleshooting on the maintenance object based on the fault troubleshooting link graph and the identity of the maintenance object, determine a root cause of a fault corresponding to the problem description, generate the fault troubleshooting report, and return the fault troubleshooting report to the proxy module.

In the embodiment of the present disclosure, the debugging interface is a representational state transfer application programming interface and is configured to receive the operation and maintenance information for the maintenance object submitted by an alarm module, an inspection module, or an administrator module in the service management platform.

In the embodiment of the present disclosure, the proxy module includes:
a mapping relationship storage module, configured to store a first mapping relationship between preset environment information and a backend cloud environment;
an operation and maintenance information reception module, configured to receive the operation and maintenance information from the debugging interface;
an environment information extraction module, configured to extract the environment information from the received operation and maintenance information;
a mapping module, configured to determine a target backend cloud environment corresponding to the maintenance object based on the first mapping relationship and the extracted environment information; and
a forwarding module, configured to submit the received operation and maintenance information to a fault troubleshooting engine corresponding to the target backend cloud environment, and return the fault troubleshooting report from the fault troubleshooting engine to the debugging interface.

In the embodiment of the present disclosure, the fault troubleshooting engine includes:
a problem representation extraction module, configured to extract the information on problem description from the operation and maintenance information;
a fault troubleshooting link graph planning module, configured to store at least one preset fault troubleshooting link graph and a second mapping relationship between the information on problem description and the fault troubleshooting link graph, and determine a target fault troubleshooting link graph corresponding to the information on the problem description based on the second mapping relationship;
an inspection and analysis module, configured to perform fault troubleshooting on the maintenance object based on the target fault troubleshooting link graph, and determine a root cause of a fault corresponding to the problem description;
a problem repair module, configured to generate a fault repair solution based on the root cause of the fault; and
a reporting module, configured to generate a fault troubleshooting report based on the target fault troubleshooting link graph, the root cause of the fault, and the fault repair solution, and return the fault troubleshooting report to the proxy module.

In the embodiment of the present disclosure, the fault troubleshooting link graph includes at least one branch sub-link, and each branch sub-link includes at least one node, wherein each branch sub-link corresponds to one type of fault cause, and each node corresponds to one specific fault cause and defines a fault troubleshooting method and an attribution condition.

In the embodiment of the present disclosure, the inspection and analysis module separately performs, for each node included in the fault troubleshooting link graph, the fault troubleshooting method corresponding to the node to determine whether the maintenance object meets an attribution condition corresponding to a current node, until it is determined that the maintenance object meets the attribution condition corresponding to the current node, and uses a specific fault cause corresponding to the current node as the root cause of the fault corresponding to the problem description.

In the embodiment of the present disclosure, the fault troubleshooting link graph planning module is further configured to assign one priority to each branch sub-link.

The inspection and analysis module determines a target branch sub-link from the at least one branch sub-link according to an order of the priorities from high to low; and separately performs, for each node of the at least one node included in the target branch sub-link, the fault troubleshooting method corresponding to the node.

In the embodiment of the present disclosure, the inspection and analysis module selects a target node from the at least one node included in the target branch sub-link by using binary search and performs the fault troubleshooting method corresponding to the target node.

The fault troubleshooting method according to the embodiment of the present disclosure includes: receiving operation and maintenance information for a specific maintenance object submitted by a service management platform, wherein the operation and maintenance information includes: an identity of the maintenance object, information on problem description, and environment information: determining a backend cloud environment corresponding to the service management platform based on the environment information in the operation and maintenance information: submitting the operation and maintenance information to a fault troubleshooting engine corresponding to the backend cloud environment; and determining, by the fault troubleshooting engine, a fault troubleshooting link graph corresponding to the information on the problem description in the operation and maintenance information based on the information on the problem description, performing fault troubleshooting on the maintenance object corresponding to the maintenance object information based on the fault troubleshooting link graph, determining a root cause of a fault corresponding to the problem description, and generating a fault troubleshooting report based on the root cause of the fault, and feeding back the fault troubleshooting report to the service management platform.

In the embodiment of the present disclosure, the method further includes: pre-storing a first mapping relationship between the environment information and the backend cloud environment, wherein determining the backend cloud environment corresponding to the service management platform based on the environment information in the operation and maintenance information includes: determining the backend cloud environment corresponding to the service management platform based on the first mapping relationship and the environment information in the received operation and maintenance information.

In the embodiment of the present disclosure, the method further includes: storing at least one preset fault troubleshooting link graph and a second mapping relationship between the information on the problem description and the fault troubleshooting link graph, where determining the fault troubleshooting link graph corresponding to the information on the problem description in the operation and maintenance information based on the information on the problem description includes: extracting the information on the problem description from the operation and maintenance information; and determining a target fault troubleshooting link graph corresponding to the extracted information on problem description based on the second mapping relationship.

In the embodiment of the present disclosure, the fault troubleshooting link graph includes at least one branch sub-link, and each branch sub-link includes at least one node, where each branch sub-link corresponds to one type of fault cause, and each node corresponds to one specific fault cause and defines a fault troubleshooting method and an attribution condition.

In the embodiment of the present disclosure, performing fault troubleshooting on the maintenance object corresponding to the maintenance object information based on the fault troubleshooting link graph and determining the root cause of the fault corresponding to the problem description includes: separately performing, for each node included in the fault troubleshooting link graph, the fault troubleshooting method corresponding to the node to determine whether the maintenance object meets an attribution condition corresponding to a current node, until it is determined that the maintenance object meets the attribution condition corresponding to the current node, and using a specific fault cause corresponding to the current node as the root cause of the fault corresponding to the problem description.

In the embodiment of the present disclosure, the method further includes: assigning one priority to each branch sub-link, where separately performing, for each node included in the fault troubleshooting link graph, the fault troubleshooting method corresponding to the node includes: determining a target branch sub-link from the at least one branch sub-link according to an order of the priorities from high to low; and separately performing, for each node of the at least one node included in the target branch sub-link, the fault troubleshooting method corresponding to the node.

In the embodiment of the present disclosure, separately performing, for each node of the at least one node included in the target branch sub-link, the fault troubleshooting corresponding to the node includes: selecting a target node from the at least one node included in the target branch sub-link by using binary search; and performing the fault troubleshooting method corresponding to the target node.

In addition, an embodiment of the present disclosure further provides an electronic device, including: a memory, a processor, and a computer program stored in the memory and executable by the processor, wherein the processor, when executing the program, implements the foregoing fault troubleshooting method.

An embodiment of the present disclosure further provides a non-transitory computer-readable storage medium, storing computer instructions, where the computer instructions are configured to cause a computer to perform the foregoing fault troubleshooting method.

An embodiment of the present disclosure further provides a computer program product, including computer program instructions, where the computer program instructions, when running on a computer, cause the computer to perform the foregoing fault troubleshooting method.

### BRIEF DESCRIPTION OF THE DRAWINGS

To illustrate the technical solutions in the present disclosure or in the related art more clearly, the following briefly introduces the drawings required for describing the embodiments or the related art. Apparently, the drawings in the following description show merely some embodiments of the present disclosure, and a person of ordinary skill in the art may still derive other drawings from these drawings without creative efforts.

FIG. 1 shows a structure of an operation and maintenance platform according to some embodiments of the present disclosure.

FIG. 2 shows an internal structure of a proxy module according to some embodiments of the present disclosure.

FIG. 3 shows an internal structure of a fault troubleshooting engine according to some embodiments of the present disclosure.

FIG. 4 shows a schematic diagram of a fault troubleshooting link graph according to some embodiments of the present disclosure.

FIG. 5 shows an implementation process of a fault troubleshooting method according to some embodiments of the present disclosure.

FIG. 6 shows a schematic diagram of a more specific hardware structure of an electronic device according to some embodiments of the present disclosure.

### DETAILED DESCRIPTION OF EMBODIMENTS

To make the objectives, technical solutions, and advantages of the present disclosure clearer, the present disclosure is further described in detail below with reference to specific embodiments and the drawings.

It should be noted that, unless otherwise defined, the technical or scientific terms used in the embodiments of the present disclosure should have the ordinary meanings as understood by those with ordinary skills in the field to which the present disclosure belongs. The terms such as “first”, “second”, and the like used in the embodiments of the present disclosure do not denote any order, quantity; or importance, but are merely used to distinguish between different components. The terms such as “include/comprise”, “including/comprising”, and the like mean that the elements or objects preceding the terms include the elements or objects listed after the terms and their equivalents, but do not exclude other elements or objects. The terms such as “connect/connected” or “couple/coupled” are not limited to physical or mechanical connections, but may include electrical connections, whether direct or indirect. The terms such as “on”, “under”, “left”, and “right” are only used to indicate relative positional relationships, and when an absolute position of a described object changes, the relative positional relationships may also change accordingly.

It may be understood that before the technical solutions of the embodiments of the present disclosure are used, the user will be informed of a type, a usage scope, a usage scenario, and the like of the involved personal information in an appropriate manner, and the authorization of the user is obtained.

For example, in response to receiving an active request from the user, prompt information is sent to the user to explicitly prompt the user that the operation requested to be performed will require the acquisition and use of the user's personal information. Therefore, the user can independently select whether to provide personal information to the software or hardware, such as the electronic device, application, server, or storage medium that performs the operation of the technical solution of the present disclosure, according to the prompt information.

As an optional but not limited implementation, in response to receiving the active request from the user, the prompt information may be sent to the user in the form of a pop-up window, and the prompt information may be presented in text in the pop-up window. In addition, the pop-up window may also carry a selection control for the user to select “agree” or “disagree” to provide the personal information to the electronic device.

It may be understood that the above process of notifying and obtaining the user's authorization is only schematic and does not constitute a limitation of the implementation of the present disclosure, and other methods that satisfy relevant laws and regulations may also be applied to the implementation of the present disclosure.

As mentioned above, when there are more deployment environments of a service platform or the service platform provides more services, the maintenance costs, especially the labor costs, of the service platform will accordingly keep increasing. To reduce the maintenance costs of the service platform and improve the maintenance efficiency of the service platform, there is an urgent need for an operation and maintenance platform that can automatically perform problem discovery, problem analysis, and problem repair and reporting in the running process of the service platform.

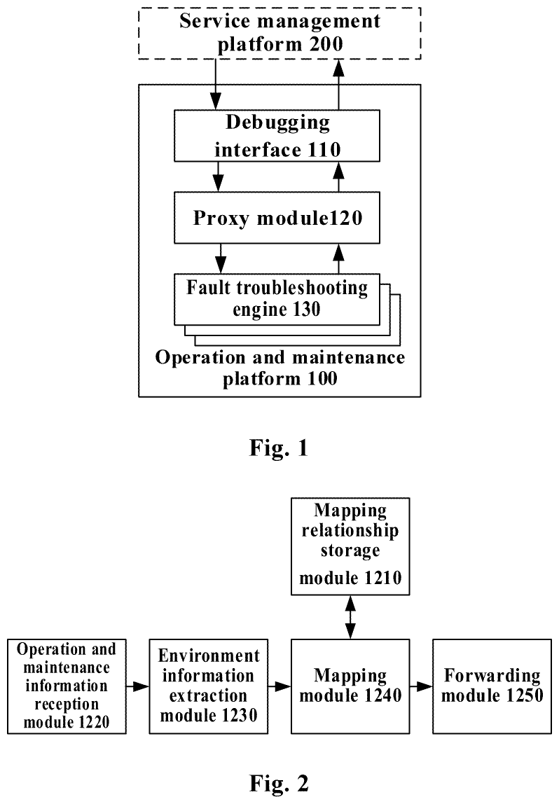

To solve the above problem, an embodiment of the present disclosure provides an operation and maintenance platform. FIG. 1 shows the structure of an operation and maintenance platform according to some embodiments of the present disclosure. As shown in FIG. 1, the operation and maintenance platform 100 according to the embodiment of the present disclosure may include: a debugging interface 110, a proxy module 120, and multiple fault troubleshooting engines 130.

In the embodiment of the present disclosure, the debugging interface 110 is mainly configured to receive the operation and maintenance information for a specific maintenance object submitted by the service management platform 200. The debugging interface 110 is further configured to return the fault troubleshooting report generated by the fault troubleshooting engine 130 to the service management platform 200.

In the embodiment of the present disclosure, the service management platform 200 may usually refer to a front-end application for service management, such as an application client or a browser, and may generally include modules that can actively or passively discover various problems in the running process of the service platform, such as an alarm module 210, an inspection module 220, or an administrator module (On Call) 230. The alarm module 210 and the inspection module 220 may passively discover problems in the running of the service platform according to their configuration information, and submit the operation and maintenance information related to the discovered problems to the operation and maintenance platform 100 when a problem is discovered. The administrator module 230 may usually be operated by an on-duty administrator, who can actively discover problems in the running process of the service platform, and fill in a preset form to submit the operation and maintenance information related to the discovered problems to the operation and maintenance platform 100, when a problem is discovered. These forms define which specific operation and maintenance information needs to be reported when a problem is discovered. For the operation and maintenance information that can be directly extracted by the service management platform 200, the operation and maintenance information can be automatically filled in the form and then submitted by the administrator.

In the embodiment of the present disclosure, the maintenance object may usually refer to an object managed and maintained by the service management platform 200. For example, in terms of a recommendation platform, the maintenance objects of the recommendation platform may usually include: tasks, models, strategics, and the like.

In the embodiment of the present disclosure, the operation and maintenance information may specifically include: an identity of the maintenance object, information on problem description, environment information, and the like. The identity of the maintenance object may be an ID of the maintenance object, etc., which is used to inform the operation and maintenance platform 100 which specific maintenance object has a problem. Then, for the recommendation platform, the maintenance object information may include: a task ID, a model ID, a strategy ID, and the like. The information on the problem description usually refers to problem representation description information corresponding to the discovered problem. For example, for the maintenance object such as a task, problems such as task failure or task delay usually occur, and thus for the maintenance object such as a task, the information on the problem description may include: task failure, task delay, and the like. For another example, for the maintenance object such as a model, problems such as slow model training or inconsistent online and offline inference effects usually occur, and for the maintenance object such as a model, the information on the problem description may include: slow training, inconsistent online and offline effects, and the like. For another example, for the maintenance object such as a strategy; problems such as strategy failure usually occur, and for the maintenance object such as a strategy, the information on the problem description may include: strategy failure, and the like. As mentioned above, with the continuous development of Internet technologies across the world, various Internet service platforms, including recommendation platforms, usually have multiple deployment environments around the world, and the specific operation and maintenance methods may be different for different deployment environments. Therefore, the environment information refers to information that can be used by the operation and maintenance platform to infer the backend cloud environment corresponding to the maintenance object, for example, a uniform resource identifier (URI) of the maintenance object, and the like.

In some embodiments of the present disclosure, the debugging interface 110 may specifically be a representational state transfer application programming interface (Restful API). Using the Restful API as the debugging interface 110 can separate the concerns between the client and the server and associate the operation and maintenance platform with functions that are frequently used by users, such as On Call/alarm/inspection report, thereby improving the decoupling and maintainability of the system and realizing the compatibility of front ends in multiple cloud environments.

The Restful API may adopt the POST method, and its request body may specify specific debugging input parameters in json format. In addition, to avoid misuse by privatized customers after deployment to the backend cloud environment, basic authentication may also be performed by using a fixed API key, thereby ensuring the security of the service.

In some embodiments of the present disclosure, the proxy module 120 is mainly configured to receive the operation and maintenance information from the debugging interface 110, determine the backend cloud environment corresponding to the maintenance object based on the environment information in the operation and maintenance information, and submit the operation and maintenance information to the fault troubleshooting engine 130 corresponding to the backend cloud environment. The proxy module 120 may further be configured to receive the fault troubleshooting report generated by the fault troubleshooting engine 130 and feedback the same to the debugging interface 110.

In some embodiments of the present disclosure, the internal structure of the proxy module 120 may be as shown in FIG. 2 and includes the following multiple modules.

A mapping relationship storage module 1210 is configured to store a first mapping relationship between preset environment information and a backend cloud environment.

In the embodiment of the present disclosure, different backend cloud environments may be identified by a domain name system (Domain Name System, DNS), and the environment information may be identified by a URI of the maintenance object. Therefore, in the embodiment of the present disclosure, a first mapping relationship between the URI of the maintenance object and the DNS of the backend cloud environment may be established. For example, in some embodiments, the first mapping relationship may refer to that the DNS of the corresponding backend cloud environment can be obtained by performing specific processing on the URI of the maintenance object.

An operation and maintenance information reception module 1220 is configured to receive the operation and maintenance information for the maintenance object from the debugging interface 110.

An environment information extraction module 1230 is configured to extract the environment information from the received operation and maintenance information.

A mapping module 1240 is configured to determine a target backend cloud environment corresponding to the maintenance object based on the first mapping relationship and the extracted environment information.

A forwarding module 1250 is configured to submit the received operation and maintenance information to a fault troubleshooting engine corresponding to the target backend cloud environment, and return the fault troubleshooting report from the fault troubleshooting engine to the debugging interface 110.

The data communication link from the service management platform to the operation and maintenance platform may be implemented through the above proxy module 120. The service management platform may currently transmit images, software configuration management (SCM), TCC configuration for distributed transaction solution, upgrade instructions, and the like to various backend cloud environments and receive upgrade feedback from the operation and maintenance platform. The fault troubleshooting engines 130 may be deployed separately in various backend cloud environments and then exposed to the outside through the proxy module 120 of the operation and maintenance platform.

In the embodiment of the present disclosure, each of the multiple fault troubleshooting engines 130 corresponds to one backend cloud environment, and the multiple fault troubleshooting engines 130 separately store multiple fault troubleshooting link graphs corresponding to the information on the problem description. In the embodiment of the present disclosure, the fault troubleshooting link graph is mainly configured to define the execution logic of fault troubleshooting, and may also be referred to as a fault troubleshooting posture.

In the embodiment of the present disclosure, each of the fault troubleshooting engines 130 is configured to: first, determine the fault troubleshooting link graph corresponding to the information on the problem description in the operation and maintenance information based on the information on the problem description; then, perform fault troubleshooting on the maintenance object corresponding to the maintenance object information based on the fault troubleshooting link graph, and determine the root cause of the fault corresponding to the problem description; then, generate the fault troubleshooting report; and return the generated fault troubleshooting report to the proxy module 120.

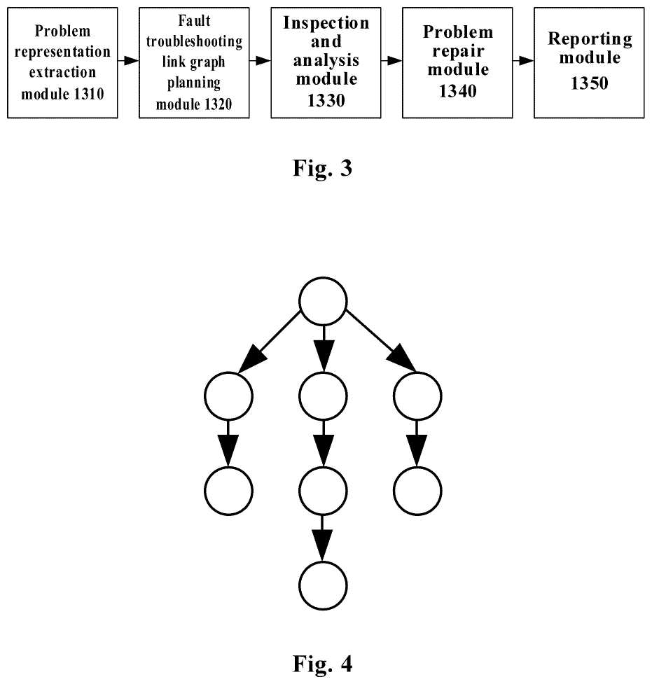

Specifically, in the embodiment of the present disclosure, the internal structure of the fault troubleshooting engine 130 may be as shown in FIG. 3 and mainly includes:
a problem representation extraction module 1310, configured to extract the information on the problem description from the operation and maintenance information;
a fault troubleshooting link graph planning module 1320, configured to store at least one preset fault troubleshooting link graph and a second mapping relationship between the information on the problem description and the fault troubleshooting link graph and determine a target fault troubleshooting link graph corresponding to the extracted information on problem description based on the second mapping relationship;
an inspection and analysis module 1330, configured to perform fault troubleshooting on the maintenance object based on the target fault troubleshooting link graph and determine the root cause of the fault corresponding to the extracted problem description;
a problem repair module 1340, configured to generate a fault repair solution based on the root cause of the fault;
a reporting module 1350, configured to generate a fault troubleshooting report based on the target fault troubleshooting link graph, the root cause of the fault, and the fault repair solution and return the fault troubleshooting report to the proxy module 120.

In the embodiment of the present disclosure, the fault troubleshooting link graph may be a directed acyclic graph (DAG) including multiple nodes as shown in FIG. 4. In some embodiments of the present disclosure, the fault troubleshooting link graph may include at least one branch sub-link. Each branch sub-link corresponds to one type of fault cause. For example, there may be multiple causes for the problem representation of task failure, including, for example, insufficient resource allocation, unreasonable task configuration, or problems with task logic, and the like. In this manner, the fault troubleshooting link graph corresponding to the problem description of task failure will include a branch sub-link corresponding to the fault cause of insufficient resource allocation, a branch sub-link corresponding to the fault cause of unreasonable task configuration, and a branch sub-link corresponding to the fault cause of problems with task logic. Each of the above branch sub-links will define a specific fault troubleshooting link for its corresponding type of fault cause.

The reason for setting at least one branch sub-link in the above fault troubleshooting link graph lies in that: currently, the services provided by service platforms, such as recommendation platforms, are usually complex service links with front-to-back coupling relationships. When such a complex service link with a front-to-back coupling relationship has a problem, it is also a complex problem to locate and troubleshoot the fault. Moreover, for the above complex service link with a front-to-back coupling relationship, there may be multiple causes for a certain problem representation, and therefore, multiple forking logics may be derived in the process of fault analysis and troubleshooting. Based on the above conditions, the fault troubleshooting link graph is defined by DAG, and at least one branch sub-link is set in the predefined fault troubleshooting link graph, and each branch sub-link corresponds to one type of fault cause, so that the forking logic between multiple fault causes that induce the problem representation can be more clearly represented. In this manner, in the process of troubleshooting the problem occurring in the maintenance object according to the fault troubleshooting link graph, the respective branch sub-links may be troubleshot in turn, so that the root cause of the fault corresponding to the extracted problem description can be quickly found, thereby improving the efficiency of fault troubleshooting. It may be seen that the fault troubleshooting link graph configured in this manner can more clearly represent the forking logic between multiple causes of the task failure, thereby improving the efficiency of fault troubleshooting.

In addition, as mentioned above, the services currently provided by the service platform are usually complex service links with front-to-back coupling relationships. When the fault troubleshooting is performed on such a service link, its corresponding fault troubleshooting link usually also has a front-to-back coupling relationship. Based on this, in the embodiment of the present disclosure, each of the above branch sub-links will include at least one node. Generally, the at least one node also has a front-to-back coupling relationship. Each of the at least one node corresponds to one specific fault cause, and each node may define one specific fault troubleshooting method and an attribution condition. When the fault troubleshooting method defined by a certain node is performed and it is determined that the attribution condition defined by the node is met, it may be considered that the specific fault cause corresponding to the node is the root cause of the fault corresponding to the problem description. For example, the branch sub-link corresponding to the fault cause of insufficient resources may include multiple nodes, and each node defines one specific fault troubleshooting method and an attribution condition for determining whether the task failure is specifically caused by insufficient resources. In the process of performing the fault troubleshooting method defined by a certain node, the amount of resources applied for by the task during running, the amount of resources actually required and the like can be reviewed in the service for resource allocation, thereby determining whether the task failure is caused by insufficient resources. Alternatively, the fault troubleshooting method defined by a certain node may also be performed by querying logs. The embodiment of the present disclosure does not limit the specific manner of the fault troubleshooting method defined by each node. If it is determined that the attribution condition defined by a certain node is met after the fault troubleshooting method defined by the node is performed, it may be determined that the root cause of the fault corresponding to the problem description is the specific fault cause corresponding to the node, for example, the task failure is caused by insufficient resources.

That is, in the embodiment of the present disclosure, the inspection and analysis module 1330 separately performs, for each node included in the fault troubleshooting link graph, the fault troubleshooting method corresponding to the node to determine whether the maintenance object meets the attribution condition corresponding to the current node, until it is determined that the maintenance object meets the attribution condition corresponding to a certain node, and the specific fault cause corresponding to the node is used as the root cause of the fault corresponding to the problem description.

In the embodiment of the present disclosure, to further improve the efficiency of fault troubleshooting, the logical order of performing fault troubleshooting based on the fault troubleshooting link graph will also be set. Specifically, the fault troubleshooting link graph planning module 1320 may further be configured to set one priority for each branch sub-link of the fault troubleshooting link graph. The higher the priority is, the greater the possibility that the specific fault cause corresponding to the node included in the branch sub-link is the root cause of the fault is. In the embodiment of the present disclosure, the priority may usually be set according to the analysis result of historical data of operation and maintenance, that is, a higher priority is set for the branch sub-link corresponding to the type of fault cause that is more likely to be the root cause of the fault based on the statistical information. It is found through statistics that for the same type of fault, about 80% of the faults are caused by 20% of the fault causes. Therefore, setting a higher priority for the 20% of the fault causes can greatly improve the efficiency of fault troubleshooting.

In the above case, the inspection and analysis module 1330 may first determine a target branch sub-link from the at least one branch sub-link according to an order of the set priorities from high to low: then, separately perform, for each node of the at least one node included in the target branch sub-link, the fault troubleshooting method corresponding to the node, until the attribution condition of a certain node is met.

For a branch sub-link with a front-to-back coupling relationship between nodes, a target node may be selected from the at least one node included in the branch sub-link by using binary search; then, the fault troubleshooting method corresponding to the target node is performed. A range of nodes corresponding to the fault may be quickly determined by using the binary search, thereby quickly finding the node corresponding to the fault and then determining the root cause of the fault corresponding to the problem description. A simple example is used for illustration. When a branch sub-link includes five nodes A, B, C, D, and E that have a front-to-back coupling relationship, a problem with any of the nodes may cause the entire branch sub-link to have a problem. Therefore, when a fault is troubleshot for the above branch sub-link, the binary search may be used to determine that the target node is the middle node C of the link, and the middle node C of the link is troubleshot, and the fault troubleshooting method corresponding to the node C is performed. If the attribution condition of the node C is met, it may be determined that the node with the problem may be A, B, or C. Next, the binary search may be further used to determine that the target node is the middle node B, and the middle node B is continuously troubleshot. If the attribution condition of the node C is not met, it may be determined that the node with the problem may be D or E. Next, the binary search may be used to determine that the target node is the middle node D, and the node D is further troubleshot, . . . , thereby finding the node that causes the entire branch sub-link to have a problem, thereby determining the root cause of the fault corresponding to the problem description.

In the embodiment of the present disclosure, the problem repair module 1340 may preset and store the fault repair solution corresponding to the root cause of the fault. It may be understood that after the root cause of the fault is located, the fault repair solution may also be determined accordingly. For example, when it is determined that the root cause of the fault is insufficient resource allocation, which induces the task failure, the allocation of the resource may be increased to repair the fault. Based on the above configuration, after determining the root cause of the fault corresponding to the problem description, the problem repair module 1340 may automatically generate a fault repair solution based on the fault repair solution corresponding to the root cause of the fault stored therein and the root cause of the fault corresponding to the problem description.

In the embodiment of the present disclosure, the reporting module 1350 may generate a fault troubleshooting report based on the target fault troubleshooting link graph, the root cause of the fault, and the fault repair solution, and return the fault troubleshooting report to the proxy module 120.

In the embodiment of the present disclosure, the reporting module 1350 may also add to the fault troubleshooting report the details of the process of performing fault troubleshooting based on the target fault troubleshooting link graph, thereby assisting the service management platform in performing review.

In the embodiment of the present disclosure, the fault repair solution may be automatically executed for one time, thereby ensuring atomicity, and a retry configuration or a manual retry function is provided for the service management platform. In addition, an alarm notification is provided for the failure of the execution of the fault repair solution.

It may be seen from the above solution that the operation and maintenance platform according to the embodiments of the present disclosure can automatically perform problem discovery, problem analysis, and problem repair and reporting in the running process of the service platform. The operation and maintenance platform can support not only different backend cloud environments. Furthermore, the operation and maintenance platform may support the flexible configuration of DAG to define the troubleshooting link, so that the fault troubleshooting can be quickly and automatically performed for the discovered problem representation, which greatly reduces manual operations, thereby greatly reducing the labor costs required for the operation and maintenance of the service platform.

Furthermore, the operation and maintenance platform according to the embodiments of the present disclosure supports branch judgment logic and supports the configuration of priorities for different branches, thereby further greatly improving the efficiency of fault troubleshooting.

Specifically, the current recommendation platform usually has to maintain more than ten backend cloud environments, and each backend cloud environment also has dozens of services. From the overall service perspective of the recommendation platform, the debugging of complex links is the most time-consuming, and there are multiple relatively critical complex links in the service links of the recommendation platform. It may be understood that the complex links existing in the recommendation platform usually include: a forward ranking link, a candidate link, an inverted ranking link, an online strategy; a streaming sample, a real-time feature, model training, and the like. With the technical solutions according to the embodiments of the present disclosure, the standardized troubleshooting posture on the fixed complex link may be automated to quickly narrow down the problem space, thereby greatly reducing the labor troubleshooting costs.

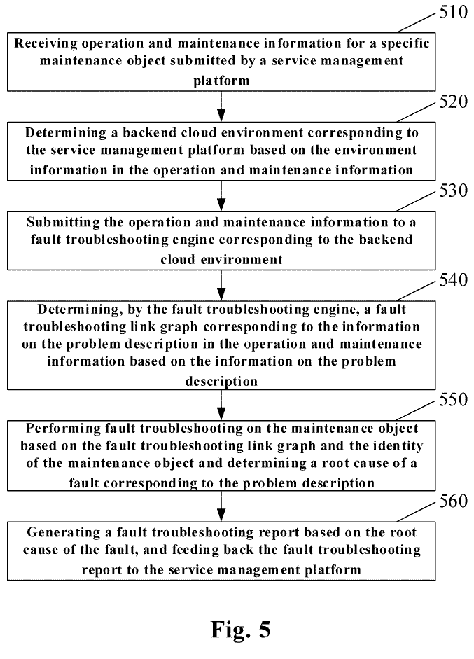

Corresponding to the above operation and maintenance platform, an embodiment of the present disclosure further provides a fault troubleshooting method. FIG. 5 shows the implementation process of the above fault troubleshooting method. As shown in FIG. 5, the above fault troubleshooting method may include:
Step 510: receiving operation and maintenance information for a specific maintenance object submitted by a service management platform, wherein the operation and maintenance information includes: an identity of the maintenance object, information on problem description, and environment information;
Step 520: determining a backend cloud environment corresponding to the service management platform based on the environment information in the operation and maintenance information;
Step 530: submitting the operation and maintenance information to a fault troubleshooting engine corresponding to the backend cloud environment;
Step 540: determining, by the fault troubleshooting engine, a fault troubleshooting link graph corresponding to the information on the problem description in the operation and maintenance information based on the information on the problem description;
Step 550: performing fault troubleshooting on the maintenance object based on the fault troubleshooting link graph and the identity of the maintenance object, and determining a root cause of a fault corresponding to the problem description; and
Step 560: generating a fault troubleshooting report based on the root cause of the fault, and feeding back the fault troubleshooting report to the service management platform.

In some embodiments of the present disclosure, the fault troubleshooting method may further include: pre-storing a first mapping relationship between the environment information and the backend cloud environment. In this case, the action of determining the backend cloud environment corresponding to the service management platform based on the environment information in the operation and maintenance information may include: determining the backend cloud environment corresponding to the service management platform based on the first mapping relationship and the environment information in the received operation and maintenance information.

In some embodiments of the present disclosure, the fault troubleshooting method may further include: storing at least one preset fault troubleshooting link graph and establishing a second mapping relationship between the information on the problem description and the fault troubleshooting link graph.

In this case, the action of fault troubleshooting engine determines the fault troubleshooting link graph corresponding to the information on the problem description in the operation and maintenance information based on the information on the problem description may include: extracting the information on the problem description from the operation and maintenance information; and determining the target fault troubleshooting link graph corresponding to the extracted information on problem description based on the second mapping relationship.

In some embodiments of the present disclosure, the fault troubleshooting link graph includes at least one branch sub-link, and each branch sub-link includes at least one node, wherein each branch sub-link corresponds to one type of fault cause, and each node corresponds to one specific fault cause and defines a fault troubleshooting method and an attribution condition.

In some embodiments of the present disclosure, the action of performing fault troubleshooting on the maintenance object corresponding to the maintenance object information based on the fault troubleshooting link graph and determining the root cause of the fault corresponding to the problem description includes: separately performing, for each node included in the fault troubleshooting link graph, the fault troubleshooting method corresponding to the node to determine whether the maintenance object meets the attribution condition corresponding to the current node, until it is determined that the maintenance object meets the attribution condition corresponding to the current node, and using the specific fault cause corresponding to the current node as the root cause of the fault corresponding to the problem description.

In some embodiments of the present disclosure, the method further includes: assigning one priority to each branch sub-link, wherein the action of separately performing, for each node included in the fault troubleshooting link graph, the fault troubleshooting method corresponding to the node includes: determining a target branch sub-link from the at least one branch sub-link according to an order of the priorities from high to low; and separately performing, for each node of the at least one node included in the target branch sub-link, the fault troubleshooting method corresponding to the node.

In some embodiments of the present disclosure, the action of separately performing, for each node of the at least one node included in the target branch sub-link, the fault troubleshooting corresponding to the node includes: selecting a target node from the at least one node included in the target branch sub-link by using binary search; and performing the fault troubleshooting method corresponding to the target node.

It may be seen from the above solution that the fault troubleshooting method according to the embodiments of the present disclosure can support not only different backend cloud environments, and the fault troubleshooting can be quickly and automatically performed for the discovered problem representation, which greatly reduces manual operations, thereby greatly reducing the labor costs required for the operation and maintenance of the service platform.

Furthermore, the fault troubleshooting method according to the embodiments of the present disclosure supports branch judgment logic and supports the configuration of priorities for different branches, thereby further greatly improving the efficiency of fault troubleshooting.

Based on the same inventive concept, corresponding to any of the foregoing embodiments, the present disclosure further provides an electronic device, including: a memory, a processor, and a computer program stored in the memory and executable by the processor, wherein the processor, when executing the program, implements the fault troubleshooting method according to any of the foregoing embodiments.

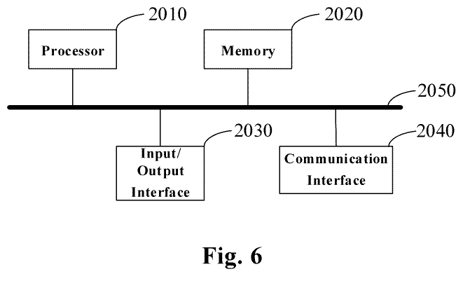

FIG. 6 shows a schematic diagram of a more specific hardware structure of an electronic device provided by this embodiment. The device may include: a processor 2010, a memory 2020, an input/output interface 2030, a communication interface 2040, and a bus 2050. The processor 2010, the memory 2020, the input/output interface 2030, and the communication interface 2040 implement communication connection between each other inside the device through the bus 2050.

The processor 2010 may be implemented by using a general-purpose CPU (Central Processing Unit), a microprocessor, an Application Specific Integrated Circuit (ASIC), or one or more integrated circuits, and is configured to execute related programs, so as to implement the technical solutions provided in the embodiments of the present specification.

The memory 2020 may be implemented in the form of a ROM (Read Only Memory), a RAM (Random Access Memory), a static storage device, a dynamic storage device, or the like. The memory 2020 may store an operating system and other applications. When the technical solutions provided in the embodiments of this specification are implemented through software or firmware, related program codes are stored in the memory 2020 and invoked by the processor 2010 for execution.

The input/output interface 2030 is configured to connect to an input/output device, to implement information input and output. The input/output device may be configured in the device as a component, or may be externally connected to the device to provide a corresponding function. For example, the input device may include a microphone, various sensors, and the like, and the output device may include a display: a speaker, a vibrator, an indicator light, and the like.

The communication interface 2040 is configured to connect to a communication module (not shown in the figure), to implement communication interaction between the device and another device. The communication module may implement communication in a wired manner (for example, USB, a network cable, or the like) or in a wireless manner (for example, a mobile network, WIFI, Bluetooth, or the like).

The bus 2050 includes a path for transmitting information between various components (for example, the processor 2010, the memory 2020, the input/output interface 2030, and the communication interface 2040) of the device.

It should be noted that although the above device only shows the processor 2010, the memory 2020, the input/output interface 2030, the communication interface 2040, and the bus 2050, in the specific implementation process, the device may also include other components necessary for normal operation. In addition, those skilled in the art can understand that the above device may also only include components necessary for implementing the solution of the embodiments of the present specification, and does not have to include all the components shown in the figure.

The electronic device of the above embodiment is used to implement the corresponding fault troubleshooting method in any of the preceding embodiments, and has the beneficial effects of the corresponding method embodiments, which will not be repeated here.

Based on the same inventive concept, corresponding to any of the foregoing embodiments, the present disclosure further provides a non-transitory computer-readable storage medium, storing computer instructions, where the computer instructions are configured to enable a computer to perform the foregoing fault troubleshooting method.

The computer-readable medium of this embodiment includes permanent and non-permanent, removable and non-removable media, and information storage may be implemented by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette, magnetic tape magnetic disk storage or other magnetic storage devices, or any other non-transmission medium, which may be used to store information that can be accessed by a computing device.

The computer instructions stored in the storage medium of the above embodiment are configured to cause the computer to perform the task handling method according to any of the above embodiments, and have the beneficial effects of the corresponding method embodiments, which will not be repeated here.

It should be understood by those of ordinary skill in the art that the discussion of any of the above embodiments is merely exemplary, and is not intended to suggest that the scope of the present disclosure (including the claims) is limited to these examples. Under the inventive concept of the present disclosure, the technical features in the above embodiments or different embodiments may also be combined, and the steps may be implemented in any order, and there are many other variations in different aspects of the embodiments of the present disclosure as described above, which are not provided in detail for the sake of brevity.

In addition, in order to simplify the description and discussion, and to avoid making the embodiments of the present disclosure difficult to understand, the well-known power/ground connections of the integrated circuit (IC) chip and other components may or may not be shown in the provided drawings. In addition, the apparatus may be shown in the form of a block diagram, so as to avoid making the embodiments of the present disclosure difficult to understand, and this also takes into account the fact that the details of the implementations of these block diagram apparatus are highly dependent on the platform on which the embodiments of the present disclosure are to be implemented (that is, these details should be completely within the understanding of those skilled in the art). In the case where specific details (for example, circuits) are described to describe exemplary embodiments of the present disclosure, it is obvious to those skilled in the art that the embodiments of the present disclosure may be implemented without these specific details or with changes in these specific details. Therefore, these descriptions should be considered as illustrative rather than restrictive.

Although the present disclosure has been described with reference to specific embodiments of the present disclosure, many alternatives, modifications, and variations of these embodiments will be apparent to those of ordinary skill in the art from the foregoing description. For example, other memory architectures (for example, dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principle of the embodiments of the present disclosure should be included in the protection scope of the present disclosure.

I/We claim:

1. An operation and maintenance platform, comprising: a debugging interface, a proxy module, and multiple fault troubleshooting engines, wherein each of the multiple fault troubleshooting engines corresponds to one backend cloud environment;
wherein the debugging interface is configured to receive operation and maintenance information for a specific maintenance object submitted by a service management platform, and return a fault troubleshooting report generated by the fault troubleshooting engine to the service management platform, and wherein the operation and maintenance information comprises: an identity of the maintenance object, information on problem description, and environment information;
wherein the proxy module is configured to receive the operation and maintenance information, determine a backend cloud environment corresponding to the maintenance object based on the environment information in the operation and maintenance information, submit the operation and maintenance information to a fault troubleshooting engine corresponding to the backend cloud environment, and return the fault troubleshooting report generated by the fault troubleshooting engine to the debugging interface; and
wherein the fault troubleshooting engine is configured to determine a fault troubleshooting link graph corresponding to the information on the problem description in the operation and maintenance information based on the information on the problem description, perform fault troubleshooting on the maintenance object based on the fault troubleshooting link graph and the identity of the maintenance object, determine a root cause of a fault corresponding to the problem description, generate the fault troubleshooting report, and return the fault troubleshooting report to the proxy module.

2. The operation and maintenance platform according to claim 1, wherein the debugging interface is a representational state transfer application programming interface and is configured to receive the operation and maintenance information for the maintenance object submitted by an alarm module, an inspection module, or an administrator module in the service management platform.

3. The operation and maintenance platform according to claim 1, wherein the proxy module comprises:
a mapping relationship storage module, configured to store a first mapping relationship between preset environment information and the backend cloud environment;
an operation and maintenance information reception module, configured to receive the operation and maintenance information from the debugging interface;
an environment information extraction module, configured to extract the environment information from the received operation and maintenance information;
a mapping module, configured to determine a target backend cloud environment corresponding to the maintenance object based on the first mapping relationship and the extracted environment information; and
a forwarding module, configured to submit the received operation and maintenance information to the fault troubleshooting engine corresponding to the target backend cloud environment, and return the fault troubleshooting report from the fault troubleshooting engine to the debugging interface.

4. The operation and maintenance platform according to claim 1, wherein the fault troubleshooting engine comprises:
a problem representation extraction module, configured to extract the information on the problem description from the operation and maintenance information;
a fault troubleshooting link graph planning module, configured to store at least one preset fault troubleshooting link graph and a second mapping relationship between the information on the problem description and the fault troubleshooting link graph, and determine a target fault troubleshooting link graph corresponding to the information on the problem description based on the second mapping relationship;
an inspection and analysis module, configured to perform the fault troubleshooting on the maintenance object based on the target fault troubleshooting link graph, and determine the root cause of the fault corresponding to the problem description;
a problem repair module, configured to generate a fault repair solution based on the root cause of the fault; and
a reporting module, configured to generate the fault troubleshooting report based on the target fault troubleshooting link graph, the root cause of the fault, and the fault repair solution, and return the fault troubleshooting report to the proxy module.

5. The operation and maintenance platform according to claim 4, wherein the fault troubleshooting link graph comprises at least one branch sub-link, and each branch sub-link corresponds to one type of fault cause, wherein each branch sub-link comprises at least one node, and each node corresponds to one specific fault cause and defines a fault troubleshooting method and an attribution condition.

6. The operation and maintenance platform according to claim 5, wherein the inspection and analysis module is further configured to separately perform, for each node comprised in the fault troubleshooting link graph, the fault troubleshooting method corresponding to the node to determine whether the maintenance object meets the attribution condition corresponding to a current node, until it is determined that the maintenance object meets the attribution condition corresponding to the current node, and use a specific fault cause corresponding to the current node as the root cause of the fault corresponding to the problem description.

7. The operation and maintenance platform according to claim 6, wherein the fault troubleshooting link graph planning module is further configured to assign one priority to each branch sub-link; and
the inspection and analysis module is further configured to determine a target branch sub-link from the at least one branch sub-link according to an order of the priorities from high to low, and separately perform, for each node of the at least one node comprised in the target branch sub-link, the fault troubleshooting method corresponding to the node.

8. The operation and maintenance platform according to claim 7, wherein the inspection and analysis module is further configured to select a target node from the at least one node comprised in the target branch sub-link by using binary search, and perform the fault troubleshooting method corresponding to the target node.

9. A fault troubleshooting method, comprising:
receiving operation and maintenance information for a specific maintenance object submitted by a service management platform, wherein the operation and maintenance information comprises: an identity of the maintenance object, information on problem description, and environment information;
determining a backend cloud environment corresponding to the service management platform based on the environment information in the operation and maintenance information;
submitting the operation and maintenance information to a fault troubleshooting engine corresponding to the backend cloud environment;
determining, by the fault troubleshooting engine, a fault troubleshooting link graph corresponding to the information on the problem description in the operation and maintenance information based on the information on the problem description;
performing fault troubleshooting on the maintenance object corresponding to maintenance object information based on the fault troubleshooting link graph and determining a root cause of a fault corresponding to the problem description; and
generating a fault troubleshooting report based on the root cause of the fault, and feeding back the fault troubleshooting report to the service management platform.

10. The fault troubleshooting method according to claim 9, further comprising: pre-storing a first mapping relationship between the environment information and the backend cloud environment, wherein
determining the backend cloud environment corresponding to the service management platform based on the environment information in the operation and maintenance information comprises: determining the backend cloud environment corresponding to the service management platform based on the first mapping relationship and the environment information in the received operation and maintenance information.

11. The fault troubleshooting method according to claim 9, further comprising: storing at least one preset fault troubleshooting link graph and a second mapping relationship between the information on the problem description and the fault troubleshooting link graph, wherein
determining the fault troubleshooting link graph corresponding to the information on the problem description in the operation and maintenance information based on the information on the problem description comprises: extracting the information on the problem description from the operation and maintenance information; and determining a target fault troubleshooting link graph corresponding to the extracted information on the problem description based on the second mapping relationship.

12. The fault troubleshooting method according to claim 11, wherein the fault troubleshooting link graph comprises at least one branch sub-link, and each branch sub-link corresponds to one type of fault cause, wherein each branch sub-link comprises at least one node, and each node corresponds to one specific fault cause and defines a respective fault troubleshooting method and an attribution condition.

13. The fault troubleshooting method according to claim 12, wherein performing fault troubleshooting on the maintenance object corresponding to the maintenance object information based on the fault troubleshooting link graph and determining the root cause of the fault corresponding to the problem description comprises: separately performing, for each node comprised in the fault troubleshooting link graph, the fault troubleshooting method corresponding to the node to determine whether the maintenance object meets the attribution condition corresponding to a current node, until it is determined that the maintenance object meets the attribution condition corresponding to the current node, and using a specific fault cause corresponding to the current node as the root cause of the fault corresponding to the problem description.

14. The fault troubleshooting method according to claim 13, further comprising: assigning one priority to each branch sub-link, wherein
separately performing, for each node comprised in the fault troubleshooting link graph, the fault troubleshooting method corresponding to the node comprises: determining a target branch sub-link from the at least one branch sub-link according to an order of the priorities from high to low; and separately performing, for each node of the at least one node comprised in the target branch sub-link, the fault troubleshooting method corresponding to the node.

15. The fault troubleshooting method according to claim 14, wherein separately performing, for each node of the at least one node comprised in the target branch sub-link, the fault troubleshooting corresponding to the node comprises: selecting a target node from the at least one node comprised in the target branch sub-link by using binary search; and performing the fault troubleshooting method corresponding to the target node.

16. An electronic device, comprising: a memory, a processor, and a computer program stored in the memory and executable by the processor, wherein the processor, when executing the program, causes the electronic device to:
receive operation and maintenance information for a specific maintenance object submitted by a service management platform, wherein the operation and maintenance information comprises: an identity of the maintenance object, information on problem description, and environment information;
determine a backend cloud environment corresponding to the service management platform based on the environment information in the operation and maintenance information;
submit the operation and maintenance information to a fault troubleshooting engine corresponding to the backend cloud environment;
determine, by the fault troubleshooting engine, a fault troubleshooting link graph corresponding to the information on the problem description in the operation and maintenance information based on the information on the problem description;
perform fault troubleshooting on the maintenance object corresponding to maintenance object information based on the fault troubleshooting link graph and determine a root cause of a fault corresponding to the problem description; and
generate a fault troubleshooting report based on the root cause of the fault, and feed back the fault troubleshooting report to the service management platform.

17. The electronic device according to claim 16, wherein the processor, when executing the program, further causes the electronic device to: pre-store a first mapping relationship between the environment information and the backend cloud environment,
wherein the program causing the electronic device to determine the backend cloud environment corresponding to the service management platform based on the environment information in the operation and maintenance information causes the processor to: determine the backend cloud environment corresponding to the service management platform based on the first mapping relationship and the environment information in the received operation and maintenance information.

18. The electronic device according to claim 16, wherein the processor, when executing the program, further causes the electronic device to: store at least one preset fault troubleshooting link graph and a second mapping relationship between the information on the problem description and the fault troubleshooting link graph,
wherein the program causing the electronic device to determine the fault troubleshooting link graph corresponding to the information on the problem description in the operation and maintenance information based on the information on the problem description causes the processor to: extract the information on the problem description from the operation and maintenance information; and determine a target fault troubleshooting link graph corresponding to the extracted information on the problem description based on the second mapping relationship.

19. The electronic device according to claim 18, wherein the fault troubleshooting link graph comprises at least one branch sub-link, and each branch sub-link corresponds to one type of fault cause, wherein each branch sub-link comprises at least one node, and each node corresponds to one specific fault cause and defines a fault troubleshooting method and an attribution condition.

20. The electronic device according to claim 19, wherein the program causing the electronic device to perform fault troubleshooting on the maintenance object corresponding to the maintenance object information based on the fault troubleshooting link graph and determine the root cause of the fault corresponding to the problem description causes the processor to: separately perform, for each node comprised in the fault troubleshooting link graph, the fault troubleshooting method corresponding to the node to determine whether the maintenance object meets the attribution condition corresponding to a current node, until it is determined that the maintenance object meets the attribution condition corresponding to the current node, and use a specific fault cause corresponding to the current node as the root cause of the fault corresponding to the problem description.
